(19) United States
(12) Patent Application Publication
(10) Pub. No.: US 2016/0318034 A1
(43) Pub. Date: Nov. 3, 2016

(54) DE-ASSEMBLING SYSTEM FOR A PHOTOVOLTAIC PANEL ENABLING SALVAGE OF ORIGINAL MATERIALS

(71) Applicant: LA MIA ENERGIA SCARL, Venafro (is) (IT)

(72) Inventor: RENATO REGGI, SANT'ELIA FIUMERAPIDO (FR) (IT)

(21) Appl. No.: 15/105,332

(22) PCT Filed: Dec. 18, 2014
(86) PCT No.: PCT/IB2014/067071

§ 371 Date: Jun. 16, 2016

(30) Foreign Application Priority Data
Dec. 20, 2013 (IT) BO2013A 000701

(51) Int. Cl. B03B 9/06; B02C 21/02; B09B 3/00; B29B 17/02; B29B 17/04; B02C 13/04; B02C 23/14

(52) U.S. Cl. CPC B03B 9/061; B02C 13/04; B02C 21/02; B02C 23/14; B29B 17/02; B29B 17/0412; B09B 3/00; B29B 2017/0224; B29B 2017/0488

(57) ABSTRACT

In a deassembling system of a photovoltaic panel, a cutting machine has a counter-blade and a mobile blade for cooperating therewith, the blades formed to cut a photovoltaic panel into pieces. An oscillating hammer mill includes a chamber, teeth and hammers to break the cut pieces into glass and other fragments. A first sifting component has a sifting wall with meshes traversable by the glass fragments to enable salvaging thereof and to retain the pieces on the sifting wall. A fixed hammer mill has a chamber, teeth and hammers adapted to break up the pieces, forming fragments of plastic material and powder siliceous material, plastic materials, copper and silver. A second sifting component includes a sifting wall with meshes crossable by the powder material while retaining plastic fragments on the sifting wall for salvaging.

### DESCRIPTION OF THE INVENTION

The present invention relates to the technical sector of the photovoltaic panels. In particular, the invention relates to a deassembling system of a photovoltaic panel for enabling salvage of original materials of the photovoltaic panel.

As is known, a photovoltaic panel, once assembled, generally comprises:
a protective glass layer;
a first protective layer made of a plastic material (generally ethylene vinyl acetate EVA) arranged below the glass protective layer;
a plurality of photovoltaic cells, arranged below the first plastic protective layer, each comprising a silicone sheet (in some cases enriched for example with gallium, tellurium, cadmium) and electric circuits;
a second protective layer made of a plastic material (EVA) arranged below the plurality of photovoltaic cells;
a third protective layer made of plastic material, known in the sector as a backsheet (for example a layer made of polyvinyl fluoride, also known as Tedlar) which constitutes the bottom of the photovoltaic panel and which is arranged below the second layer of plastic material.

In particular, each photovoltaic channel can differ from another for example due to the thickness of the layers, the percentages of the materials used, the dimensions etc.

In a case in which a photovoltaic panel is to be substituted (for example due to damage or because it has reached the end of its working life), it is possible to proceed with deassembly thereof, i.e. the separation of the various layers it is made of, so as to enable salvaging of the original materials of the photovoltaic panel.

Different deassembly methods of a photovoltaic panel are known, which generally comprise following steps:
a mechanical shredding process, realised using a cutting machine, following which the photovoltaic panel is reduced to fragments;
one or thermal processes for determining, in each fragment, detachment of one or more layers from one another;
one or more chemical processes, during which the fragments are immersed in an acid solution so as to enable salvaging of silicon and some metals present in the photovoltaic cell.

However, the above-described known method exhibits some drawbacks. In fact, in order to deassemble a determined photovoltaic panel, the thermal process and the chemical process of the above-described method must be planned time by time according to the type of photovoltaic panel: this means that these processes will be different from one another for example according to the thickness of the layers of panel, the type and percentage of materials used, the dimensions thereof, and so on.

In practice, therefore, chemical agents will have to be selected, and relative doses thereof, temperatures to be used, duration of the various processes. This translates into very long working times and high design costs for each type of panel to be treated.

A further drawback relates to the fact that the thermal processes give rise to the production of gases containing highly toxic substances, which require elimination treatments that are expensive and also constitute a form of environmental risk. Further dangerous substances are contained in the water used for washing which can be used once the thermal treatment has been completed.

As regards the chemical processes, these are both expensive due to the large quantities of chemical agents used, and very dangerous for the environment.

Lastly, the energy outlay for completing the chemical and thermal processes are significant.

The aim of the present invention is to obviate the above-described drawbacks.

This aim is attained with a deassembly system of a photovoltaic panel for enabling salvaging of original materials of the photovoltaic panel according to claim 1.

The solution of the invention advantageously enables deassembly of a photovoltaic panel without any need for adjustments relating to the type of photovoltaic panel, as was the case with the prior art. In other words, the present solution is “universal” for any type of photovoltaic panel. This leads to a considerable and even almost total reduction in times and design costs with respect to the prior art.

Further, the proposed solution involves modest costs with respect to the prior art since it does not necessarily require treatment of the entire photovoltaic panel with expensive chemical and/or thermal processes, necessary in the prior art.

The environmental impact of the proposed solution is also significant lower with respect to the prior-art solutions.

Further advantages and specific embodiments of the invention will emerge from the following description, with the aid of the accompanying tables of drawings, in which:

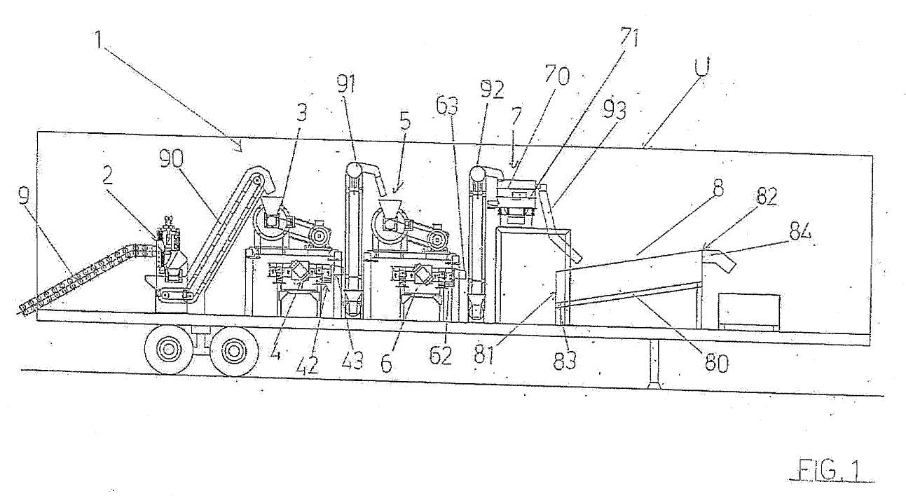

FIG. 1 is a schematic lateral view of a system according to the present invention, in a preferred embodiment thereof;

FIG. 1A illustrates a larger-scale detail of FIG. 1;

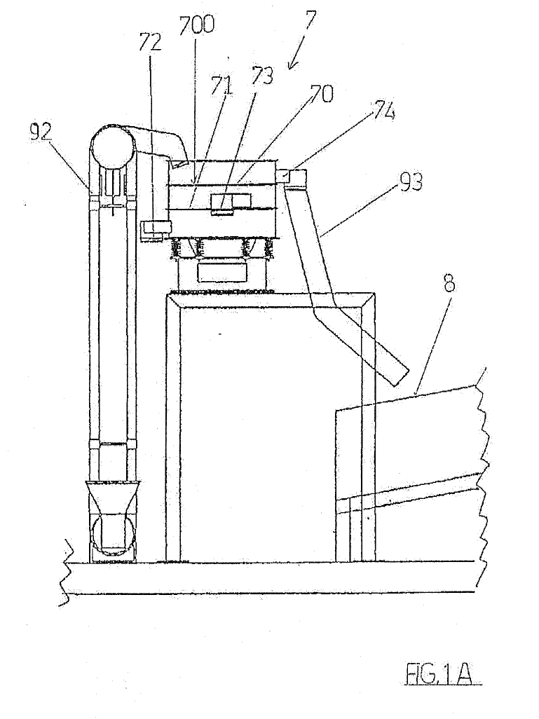

FIG. 2 is a perspective view of a cutting machine present in the system of the invention, in which some parts have been removed better to evidence others;

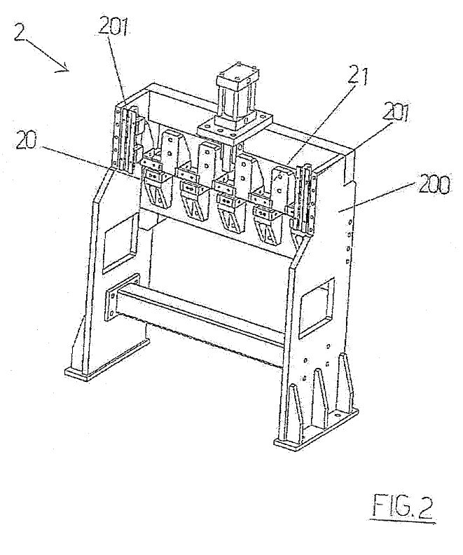

FIG. 3 is a perspective view of an oscillating hammer mill present in the system of the invention;

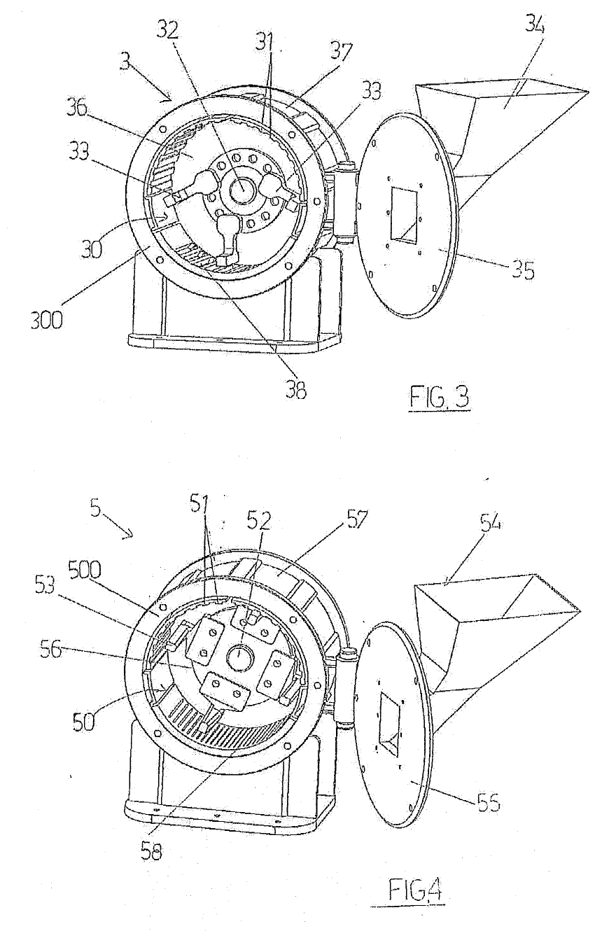

FIG. 4 is a perspective view of a fixed hammer mill present in the system of the invention.

With reference to the accompanying tables of drawings, (1) denotes a deassembling system of a photovoltaic panel for enabling salvage of original materials. Generally, a photovoltaic panel (not illustrated), once assembled, comprises: a photovoltaic cell, comprising siliceous material, copper and silver; a glass layer for protection of the photovoltaic cell; a first layer of plastic material for protecting the photovoltaic cell; a second layer of plastic material for protecting the photovoltaic cell. In particular, the photovoltaic cell is arranged between the first layer of plastic material and the second layer of plastic material. Clearly, when the photovoltaic panel is in use, the layer of (transparent) glass is external and is arranged superiorly with respect to the first layer of plastic material (which is also transparent and comprises for example ethylene vinyl acetate, also known as EVA). In turn, the first layer is arranged above the photovoltaic cell (generally a plurality of photovoltaic cells is present) and the second layer of plastic material (for example a polyvinyl fluoride layer, also known as Tedlar).

The system (1) in particular comprises: a cutting machine (2) (see in particular FIG. 2) in turn comprising: a counter-blade (20); a mobile blade (21) for cooperating with the counter-blade (20). In particular, the blade (21) and the counter-blade (20) are conformed so as to shred a photovoltaic panel, forming a plurality of shredded pieces.

The system (1) further comprises an oscillating hammer mill (3) comprising: a chamber (30) receiving the cut pieces; a plurality of facing teeth (31) which are arranged in a circular direction, which delimit the chamber (30) and which are solidly constrained to a frame (300) of the oscillating hammer mill (3); a drive shaft (32); a plurality of hammers (33) which are arranged in the chamber (30), which are drawn in rotation by the drive shaft (32) and which are freely rotatable with respect to the drive shaft (32) about rotation axes that are arranged along a portion of circumference which is concentric to the axis of the drive shaft (32); the hammers (33) and the teeth (31) being conformed and arranged to break up the cut pieces, forming fragments of glass and other broken pieces that are larger than the glass fragments.

Further, the system comprises first sifting means (4), which receive the fragments of glass and pieces; the first sifting means (4) comprising a sifting wall (not illustrated in the figures) provided with a plurality of meshes; the meshes being dimensioned in such a way as to enable the glass fragments to cross the meshes so as to enable salvaging thereof and so as to enable the pieces to remain on the sifting wall.

Further, the system (1) comprises a fixed hammer mill (5) (see FIG. 4) comprising: a chamber (50) receiving the sifted pieces from the first sifting means; a facing plurality of teeth (51) which are arranged in a circular direction, which delimit the chamber (50) and which are solidly constrained to the frame (500) of the fixed hammer mill (5); an activating drive shaft (52); a plurality of hammers (53) that are arranged in the chamber (50), which are drawn in rotation by the activating shaft (52) and which are solidly constrained to the activating shaft (52). In particular, the hammers (53) and the teeth (51) are conformed and arranged so as to break down the pieces, forming fragments of plastic material and powder material; the powder material being of smaller size than the fragments of plastic material and comprising siliceous materials, plastic materials, copper and silver.

The system (1) further comprises second sifting means (6), which receive the fragments of plastic material and the powder material. The second sifting means (6) comprise a sifting wall provided with a plurality of meshes; in particular, the meshes are sized so as to enable the powder material to cross the meshes and so as to enable the fragments of plastic material to remain on the sifting wall in order to enable salvaging thereof.

In particular, before processing the photovoltaic panels with the cutting machine (2) that is part of the system (1) of the invention, the photovoltaic panels are rid of the relative aluminium frame, if they have one. Then they are conveyed towards the cutting machine (2), for example by a first conveyor (9) which can be a part of the system (1) of the invention. For example, the first conveyor (9) can be a roller conveyor.

The cutting machine (2), with reference to FIG. 2, comprises for example a frame (200) to which the counter-blade (20) is fixed and with respect to which the blade (21) is constrained. For this purpose the frame (200) comprises for example guides (201) which enable the blade (21) to perform vertical outward and return runs, respectively nearingly and distancingly with respect to the counter-blade (21).

The cut pieces formed by the cutting machine (2) can for example have a parallelepiped or cubic shape (for example each side of the cube can measure one hundred millimetres). Each cut piece has a predetermined size and is constituted by all the layers which make up the photovoltaic panel.

By cutting is meant the full cutting of the photovoltaic panel which is arranged between the blade (21) and the counter-blade (20) which cooperate with one another, because of the nearing of the blade (21) to the counter-blade (20).

The cutting operation of a photovoltaic panel is entirely new in the sector.

In the prior art, as mentioned in the introductory part of the present patent application, cutting machines were sometimes present which included a plurality of rotating blades acting on the photovoltaic panel up to producing shredded pieces. Therefore it is clear that the complete cut guaranteed by the cutting machine (2) of the present invention was not obtained.

The fact of using a cutting machine (2) such as the one described above makes it possible to subsequently detach the glass from each cut piece.

This result could not instead be obtained using a cutting machine of the prior art: a known cutting machine, due to the blades acting by repeatedly striking the panel up to cutting it, would cause a weakening of the material, without enabling a clear detachment of the layer of glass with respect to the other layers of material (i.e. plastic material and the photovoltaic cell).

The system (1) can comprise a second conveyor (90), for conveying the cut pieces in outlet from the cutting machine (2) towards the oscillating hammers (3), which can be for example a bucket conveyor.

With reference to FIG. 3, the oscillating hammer mill (3) comprises a loading hopper (34) by means of which the cut pieces enter internally of the chamber (30).

In particular, the oscillating hammer mill (3), once more with reference to the figures, comprises a front wall (35), a rear wall (36) and an annular wall (37) interposed between the front wall (35) and the rear wall (36), and along which the teeth (31) are arranged. The front wall (35) is hinged to the annular wall (37).

The hammers (33) can be for example three in number, as in the illustrated case, angularly spaced from one another.

The arrangement (and more in particular the distance) between the hammers (33) of the oscillating hammer mill (3) and the teeth (31) and the reciprocal conformation are regulated such as to obtain the fragments of glass and the broken pieces (which comprise plastic material, siliceous material, copper, silver and very small quantities of glass).

The oscillating hammer mill (3) further comprises at least a slit (38) along the annular wall (37), arranged such that the broken material passes through the slit (38) once it has reached a determined piece size.

Technical testing has shown that following breaking using the oscillating hammer mill (3) the majority of the glass which formed the glass layer is reduced to fragments having a smaller size than the above-described pieces. For example, the pieces have a size of greater than six millimetres, while the glass fragments have a piece size of less than six millimetres.

Regarding the first sifting means (4), with reference to FIG. 1, they can be arranged below the oscillating hammer mill (3), so that the glass fragments and the broken pieces in outlet from the slit (38) of the oscillating hammer mill (3) can fall on the sifting wall of the first sifting means (4). For example, the meshes of the sifting wall of the first sifting means (6) can be six millimetres.

The first sifting means (4) can comprise a first outlet (42) arranged below the sifting wall, so as to enable the outlet of the glass fragments; these fragments can be transported towards a line dedicated to glass salvaging.

Therefore a majority of the glass present in the photovoltaic panel (about 80%) is salvaged with the system (1) of the invention.

The first screening means (4) can comprise, for example, a second outlet (43) for enabling the pieces remaining on the sifting wall to be conveyed towards the fixed-hammer mill (5).

For example, the system (1) can comprise a third conveyor (91) for conveying the pieces towards the fixed-hammer mill (5); for example, the third conveyor (91) can be a chain conveyor of a type having tubes.

The fixed-hammer mill (5) (see FIG. 4), like the oscillating hammer mill (3), can comprise a loading hopper (54) by means of which the pieces enter the chamber (50).

In particular, the fixed-hammer mill (5), once more with reference to the figures, comprises a front wall (55), a rear wall (56) and an annular wall (57) interposed between the front wall (55) and the rear wall (56), and along which the teeth (51) are arranged. The front wall (55) is hinged to the annular wall (57).

The hammers (53) can for example be four in number, as in the illustrated case, angularly spaced with respect to one another.

The arrangement (and more in particular the distance) between the hammers (53) and the teeth (51) and the reciprocal conformation are regulated so as to obtain fragments of plastic material and powder material which comprises siliceous material, plastic material, copper and silver.

The fixed-hammer mill (5) can further comprise at least a slit (58) along the annular wall (57), arranged such that the broken material passes through it once it has reached a certain piece size. Clearly the slit (58) of the fixed-hammer mill (5) will be smaller with respect to the slit (38) of the oscillating hammer mill (3).

The technical testing has shown that following the breaking by the fixed-hammer mill (5) the majority of the plastic material is reduced to fragments having a piece size that is greater than the above-mentioned powder material. For example, the fragments of plastic material have a piece size of greater than two millimetres, while the powder material has a piece size of smaller than two millimetres.

Concerning the second sifting means (6), with reference to FIG. 1, the means (6) can be arranged below the fixed-hammer mill (5), so that the fragments of plastic material and the powder material exiting from the slits of the fixed-hammer mill (5) can fall onto the relative sifting wall.

For example, the meshes of the sifting wall can have a size of two millimetres.

The second sifting means (6) can comprise a first outlet (62) arranged such as to enable outlet of the fragments of plastic material; these fragments can constitute “combustible waste” and can therefore be transported towards an incinerator plant. In this way, a majority of the plastic material present in each photovoltaic panel is salvaged with the system (1) of the invention.

The second sifting means (6) can comprise, for example, a second outlet (63), arranged below the sifting wall for enabling outlet of the powder material from the second sifting means (6).

For example, the first sifting means (4) comprise a vibrating sieve, and the second sifting means (6) comprise a vibrating sieve. For example, each vibrating sieve is mobile in vertical and horizontal movements.

Further, the system (1) can comprise third sifting means (7) which receive the powder material sifted by the second sifting means (6). In particular, technical testing has shown that the copper and the plastic material of the powder material have piece sizes that are larger than the siliceous material of the powder material; further, the siliceous material of the powder material has piece sizes that are greater than the silver of the powder material.

The third sifting means (7) comprise: a first sifting wall (70) comprising a plurality of meshes (700) dimensioned so as to enable the plastic material and the copper of the powder material to remain on the first sifting wall (70) and so as to enable the silver and the siliceous material of the powder material to pass through them; and a second sifting wall (71) which receives the silver and the siliceous materials sifted by the first sifting walls and which comprises a plurality of meshes. The meshes of the second sifting wall (71) are dimensioned so as to enable the siliceous material of the powder material to remain on the second sifting wall (71) so as to enable salvage and enable the silver of the powder material to cross them so as to enable salvage thereof (see in particular FIG. 1A).

This embodiment advantageously enables further optimising salvaging of original materials which constitute a photovoltaic panel with respect to the above-described embodiment.

Clearly the powder material in outlet from the second sifting means (6) is received by the third sifting means (7) at the relative first sifting wall (70).

With reference to the figures, the second sifting wall (71) is arranged below the first sifting wall (70).

For example, the system (1) can comprise a fourth conveyor (92) for conveying the powder material from the second outlet (63) of the second sifting means (6) to the third sifting means (7); for example, the fourth conveyor (92) is a chain conveyor.

For example, the meshes of the first sifting wall (70) of the third sifting means (7) can have a dimension of 0.5 millimetres, while the meshes of the second sifting wall (71) of the third sifting means (7) can have a size of 0.315 millimetres.

Further technical testing has shown that the majority of the plastic and copper material present in the powder material has a piece size of greater than 0.5 millimetres.

Further, technical testing has shown that the majority of siliceous material present in the powder material has a piece size comprised between 0.5 millimetres and 0.316 millimetres.

The same technical testing has shown that the majority of the silver present in the powder material has a piece size of less than 0.315 millimetres.

The third sifting means (7) can comprise: a first outlet (72) (see in particular FIG. 1A), arranged below the second sifting wall (71) for enabling outlet of the silver; a second outlet (73), arranged below the first sifting wall (70) for enabling outlet of the siliceous material; and a third outlet (74) for enabling outlet of the plastic material and the copper.

A further variant (see FIG. 1 for reference), the system (1) further comprises a separating device (8) which receives the plastic material and the copper sifted by the third sifting means (7); the separating device (8) comprising an inclined wall (80) in turn comprising a first end (81) and a second end (82), opposite the first end (81) and placed at a greater height with respect to the first end (81).

The separating device (8) further comprises a plurality of dispensing nozzles (not visible in the figures) for dispensing a fluid onto the inclined wall (80) so as to convey the plastic material towards the first end (81) of the inclined wall (80) to as to enable salvage thereof and to convey the copper towards the second end (82) of the inclined wall (80) so as to enable salvage thereof.

The separating device (8) advantageously enables further salvaging the plastic material of the powder material (which can constitute the “combustible waste” and the copper of the powder material.

The separating device (8) (also known in the sector by the term “separating table”) exploits the different specific weight of the copper and the plastic material. The plastic material, in fact, has a specific weight that is greater than that of copper. For this reason, following the dispensing of the fluid (for example water) by the dispensing nozzles, the plastic material will be brought towards the first end (81) of the inclined wall (80), while the copper will be brought towards the second end (82) of the inclined wall (80).

The inclined wall (80) is for example activatable so as to perform an elliptical movement.

The separating device (8) can further comprise a first outlet (83) arranged at the relative first end (81) for enabling outlet of the plastic material, and a second outlet (84), arranged at the second end (82), for enabling outlet of the copper.

The system (1) can further comprise a chute (93) for conveying the copper and the plastic material from the third outlet of the third sifting means (7) to the separating device (8).

The invention further relates to a mobile unit (U) comprising the above-described system (1); the mobile unit (U) is schematically illustrated in FIG. 1.

1. A deassembling system of a photovoltaic panel for enabling salvage of original materials of the photovoltaic panel, the photovoltaic panel comprising: a photovoltaic cell, comprising siliceous material, copper and silver; a glass layer for protection of the photovoltaic cell; a first layer of plastic material for protecting the photovoltaic cell; a second layer of plastic material for protecting the photovoltaic cell; the photovoltaic cell being arranged between the first layer of plastic material and the second layer of plastic material;
the system comprising:
a cutting machine comprising: a counter-blade; a mobile blade for cooperating with the counter-blade; the blade and the counter-blade being conformed so as to cut a photovoltaic panel, forming a plurality of cut pieces;
an oscillating hammer mill comprising: a chamber receiving the cut pieces; a plurality of facing teeth which are arranged in a circular direction, which delimit the chamber and which are solidly constrained to a frame of the oscillating hammer mill; a drive shaft; a plurality of hammers which are arranged in the chamber, which are drawn in rotation by the drive shaft and which are freely rotatable with respect to the drive shaft about rotation axes that are arranged along a portion of circumference which is concentric to the axis of the drive shaft; the hammers and the teeth being conformed and arranged to break up the cut pieces, forming fragments of glass and other broken pieces that are larger than the glass fragments;
first sifting means, which receive the fragments of glass and pieces; the first sifting means comprising a sifting wall provided with a plurality of meshes; the meshes being dimensioned in such a way as to enable the glass fragments to cross the meshes so as to enable salvaging thereof and so as to enable the pieces to remain on the sifting wall;
a fixed hammer mill comprising: a chamber receiving the sifted pieces from the first sifting means; a facing plurality of teeth which are arranged in a circular direction, which delimit the chamber and which are solidly constrained to the frame of the fixed hammer mill; an activating shaft; a plurality of hammers that are arranged in the chamber, which are drawn in rotation by the activating shaft and which are solidly constrained to the activating shaft; the hammers and the teeth being conformed and arranged so as to break down the pieces, forming fragments of plastic material and powder material; the powder material being of smaller size than the fragments of plastic material and comprising siliceous materials, plastic materials, copper and silver;
second sifting means, which receive the fragments of plastic material and the powder material; the second sifting means comprising a sifting wall provided with a plurality of meshes; the meshes being sized so as to enable the powder material to cross the meshes and so as to enable the fragments of plastic material to remain on the sifting wall in order to enable salvaging thereof.

2. The system of claim 1, wherein the first sifting means comprise a vibrating sieve, and wherein the second sifting means comprise a vibrating sieve.

3. The system of claim 1, further comprising:
third sifting means which receive the powder material; the copper and the plastic material of the powder material having piece sizes that are larger than the siliceous material of the powder material; the siliceous material of the powder material having piece sizes that are greater than the silver of the powder material; the third sifting means comprising: a first sifting wall comprising a plurality of meshes dimensioned so as to enable the plastic material and the copper of the powder material to remain on the first sifting wall and so as to enable the silver and the siliceous material of the powder material to pass through them; and a second sifting wall which receives the silver and the siliceous materials sifted by the first sifting walls and which comprises a plurality of meshes; the meshes being dimensioned so as to enable the siliceous material of the powder material to remain on the second sifting wall so as to enable salvage and enable the silver of the powder material to cross them so as to enable salvage thereof.

4. The system of claim 3, wherein third sifting means comprise a vibrating sieve.

5. The system of claim 3, further comprising a separating device which receives the plastic material and the copper sifted by the third sifting means; the separating device comprising an inclined wall comprising a first end and a second end, opposite the first end and placed at a greater height with respect to the first end; a plurality of dispensing nozzles for dispensing a fluid onto the inclined wall so as to convey the plastic material towards the first end of the inclined wall to as to enable salvage thereof and to convey the copper towards the second end of the inclined wall so as to enable salvage thereof.
